(19) United States
(12) Patent Application Publication
(10) Pub. No.: US 2024/0378317 A1
(43) Pub. Date: Nov. 14, 2024

(54) PERSONAL INFORMATION MANAGEMENT

(71) Applicant: Pradip MISTRY, San Diego, CA (US)

(72) Inventor: Pradip MISTRY, San Diego, CA (US)

(21) Appl. No.: 18/660,806

(22) Filed: May 10, 2024

Related U.S. Application Data
(60) Provisional application No. 63/465,466, filed on May 10, 2023.

(51) Int. Cl. G06F 21/62; G06F 21/60

(52) U.S. Cl. CPC G06F 21/6245; G06F 21/602

(57) ABSTRACT

Blockchain technology may leverage smart contracts to provide a publicly accessible system for storing and accessing personal records. An event or record deemed as personally identifiable information can be recorded as a transaction in the blockchain ledger. To access the ledger, an individual may need to satisfy conditions specified in a smart contract between the system and an individual. The conditions of access may include personal information, username(s), password(s), visual data, and biometric data. The conditions specified in the contract may evolve over time. Similarly, entities wishing to access and update personal data may need to satisfy conditions specified in a smart contract between the system and the entity. A separate smart contract may be used for every entity needing personal data access.

### RELATED APPLICATIONS

This application claims the benefit of U.S. Provisional Application No. 63/465,466, filed May 10, 2023, entitled “MANAGEMENT OF PERSONAL INFORMATION,” which is incorporated by reference herein in its entirety.

### BACKGROUND

Conventional methods and systems today for storing personally identifiable information in data silos are, in some cases, insecure and prone to hacking. Over the course of a person's lifetime, a person will accumulate various forms of identification, beginning with their medical records before birth, a birth certificate, and various identification instruments such as school/university card, driver's license, passport, etc. Today, to gain access or subscribe to a business/service, personal information must be resubmitted each time for validation, is validated differently, may be inconsistent, and when stored, it could be erroneous due to manual typing errors, software/hardware malfunctions, or deliberate modifications. In addition, entities such as medical organizations, schools, employers, travel or utility service providers, etc. will also request and store/update personally identifiable data and issue their own records and instruments.

The entity storing the data only needs it for the time it is interacting with the person, and thereafter, the information may be archived or deleted. For example, when a person is receiving treatment or at school, the person's records are retained by the entity providing the service. The stored data, regardless of when it was created and stored during a person's lifetime, is personally identifiable, belongs to the person, and a person has no way of verifying if the data stored in a particular silo was accessed, shared, modified, or even deleted. Today, when there is a major change in a person's life, change of school, job, or move to a different location or country, a person is required to resubmit all the required personally identifiable information and, in many cases, submit the same information multiple times. Furthermore, the responsibility of ensuring the submitted personal information is valid falls on the person submitting the data even though the data may have been entered manually by another person or provided by another entity on behalf of the person.

Today, to open an online account on a website, social media account, etc., a person is required to provide personal identification information. However, the information submitted may be false, duplicate, or fraudulent. Since the authentication methods utilized by many online sites are rudimentary at best, there is a proliferation of multiple anonymous and false accounts promoting disinformation, fraudulent credentials, and history.

### BRIEF SUMMARY

The embodiments herein generally relate to using blockchain technology with smart contracts to provide a publicly accessible system for storing and accessing personal records. Any event or record deemed as personally identifiable information can be recorded as a transaction in the blockchain ledger. To access the ledger the person will satisfy conditions specified in a smart contract between the system and an individual (owner of the personal data records). The conditions of access may include personal information, username(s), password(s), visual data, and biometric data, and the conditions specified in the contract will evolve over time. Similarly, entities wishing to access and update personal data may need to satisfy conditions specified in a smart contract between the system and the entity. There will be a separate smart contract for every entity needing personal data access.

Various aspects of the embodiments described herein provide one or more techniques whereby personally identifiable information is owned by the rightful single individual, the stored information has been validated and authenticated, cannot be altered, and that same information is supplied to any entity wishing to validate a person's identity.

Various aspects of the embodiments described herein can be used to attain one or more of the following potential advantages. Embodiments may provide for the safe and secure storage of data and provide authenticated and trusted personal data to systems in operation today and in the future, and/or the securing of data in a distributed ledger that is publicly accessible to the owner or an authorized entity from anywhere in the world. Embodiments may provide a commercially practicable method for any entity to validate and access personal information upon pre-authorization or real-time authorization from the owner. Some embodiments may provide entities with an attractive method for accessing personally identifiable data without the need to store personal information mitigating the need for systems to maintain large information silos and costly security processes and/or provide the same validated authentic and unaltered, i.e., trusted information to all entities. Some embodiments may provide a person or a rightful owner of data with a single system into which they can submit personal information in a secure manner that they can trust, be confident in its security, and that it is transparent about any sharing. These and other advantages will be apparent from the description to those skilled in the art.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

The herein are provided as non-limiting examples. As a person of ordinary skill in the art will appreciate, alternative embodiments may alter various components of the examples illustrated in the figures, depending on desired functionality, implementation concerns, and/or other factors.

FIG. 1 a block diagram that illustrates a permissioned blockchain-based system, according to an embodiment.

FIG. 2 is a diagram that details a process by which a new individual subscribes to the record service provided by the permissioned blockchain-based system, according to an embodiment.

FIG. 3 is a diagram that details a process by which an individual may append an individual subscriber data record, according to an embodiment.

FIG. 4 is a diagram that details a process by which a data record may be appended by a known (trusted) subscriber, according to an embodiment.

FIG. 5 is a diagram that details a process by which a subscriber accesses a data record using a Personal IDentifier (PID), according to an embodiment.

FIG. 6 is a diagram that details a process by which data is verified or a subscriber is authenticated, according to an embodiment.

FIG. 7 is a block diagram of an embodiment of a computer system.

FIG. 8 is a flow diagram of a method 800 of providing protected personal data management using a permissioned blockchain, according to an embodiment.

Like reference symbols in the various drawings indicate like elements, in accordance with certain example implementations. To reduce clutter, some items may be unlabeled. Unlabeled items in some figures may correspond with labeled items in other figures.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used, and various modifications may be made without departing from the scope of the disclosure.

This disclosure provides embodiments generally relating to a novel method and system for securing and accessing personally identifiable data. Particularly, this disclosure relates to securing, authentication, and access of personal data across a person's lifetime from anywhere in the world. More particularly, the disclosure relates to a method and system of using blockchain and smart contracts to store personally identifiable data that evolves during a person's lifetime. Specifically, embodiments provide a novel technique for a person to be the only entity that owns the data and the only entity that can authorize access to personal data. Furthermore, embodiments may allow for a system to incorporate available current and future techniques to validate a person both for access to data and for regulatory entities such as medical personnel, police, customs officers, hiring managers, schools, universities, etc., to update the data. The disclosure also applies to entities wishing to validate personal identity for reasons such as setting up a social media account, website login, bank account setup, etc., for example, which can require a person to submit personally identifiable information. Additionally, this disclosure will provide the entity requiring validation with a unique authentication identifier that indicates validation with just pertinent data required for its business, mitigating the need for that entity to store personal information in a separate silo.

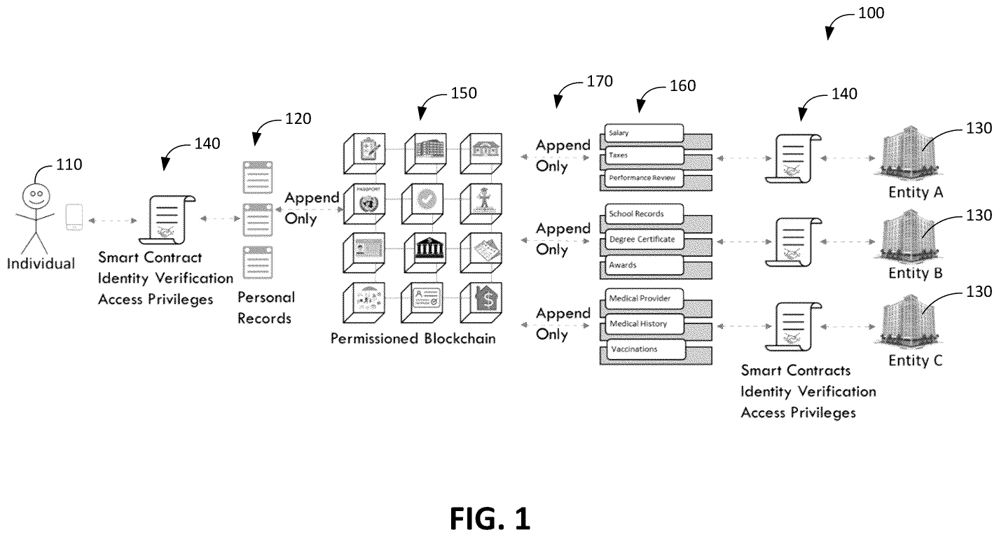

FIG. 1 is a block diagram that illustrates a permissioned blockchain-based system 100 that implements the method of storing, tracking, and managing access to personal data for an individual 110, according to an embodiment. According to some embodiments, the permissioned blockchain may be private and managed with access or membership that may be granted only to known entities and individuals (e.g., individuals and entities with verified identities). (As described herein, “known” or “trusted” entities, individuals, or subscribers may comprise entities, individuals, or subscribers whose identity has been verified, which may be part of the subscription process, as described herein.) The individual 110 owning the personal records 120 and/or one or more entities 130 wanting access to the personal records 120 may be subscribers to the system 100. The system may be available as a service (herein referred to as the “service”) available to subscribers from anywhere, provided they have access to a network/internet. (According to some embodiments, the system 100 may be implemented in the cloud as a blockchain distributed ledger, and thus, the various components may communicate via the Internet.) Upon verification, every subscriber (individual 110 or entity 130) may be assigned a set of rolling cryptographic keys that govern access to their (e.g., respective) smart contract 140 and the blockchain 150. Each subscriber 110, 130 may need to enter into a smart contract 140 which may specify the terms and conditions for data access, visibility, authentication, verification of data, and appending a new record 120. Personal records 120 appended to the blockchain 150 may include records such as a birth certificate, driver's ID, passport application/ID, medical history, medical providers, banking, investments, real-estate ownership, insurance data, academic records, affiliations, membership, patents, etc. Entities 130 may also append information 160 related to the individual 110 to the blockchain 150, such as school records, medical records, financial information, employment information, and so forth, in accordance with permissions 170 granted to the entities (e.g., via smart contracts 140). A blockchain 150 access via established permissions 170 in this manner is referred to herein as a “permissioned” blockchain.

It should be noted that although the system 100 illustrates an embodiment in which an individual 110 owns as personal record 120 that may be accessed and/or appended by entities 130 in accordance with provisions of smart contracts 140, embodiments are not necessarily limited to such “individuals” or entities. As described elsewhere herein, embodiments may be expanded beyond individuals (e.g., individual 110 in FIG. 1) to apply to companies and/or other entities having records. These records may be accessed and/or appended by other entities (e.g., entities 130) in accordance with smart contracts 140.

The system 100 may also store, manage, and update smart contracts for active subscribers 110, 130. (Herein, an “active” subscriber is an individual or an entity that has subscribed successfully, is using the system and is current with their subscription fees.) The system may allow subscribers 110, 130 options to specify conditions for accessing personal records 120 which may require further approval from one or more subscribers 110, 130.

Subscribers 110, 130, if permitted by their respective smart contract, may be able to append a new record 120. For example, an entity 130 comprising a university may submit an individual's degree results and certifications. When a new record 120 is appended, the system 100 may notify subscribers 110, 130 who have visibility access in their smart contract 140 and have opted in to receive notifications, for example.

FIG. 1 illustrates the use of a permissioned blockchain-based system 100 as a, distributed ledger to store, manage access, and track personal data record additions, according to an embodiment. Regulatory entities (e.g., entities 130) such as federal, state/local authorities may be subscribers of the system who have visibility into another subscriber's (individual, business, or organization) records and will also be able to append records. For example, a local city office will be able to access a subscriber's state business filing records and will also be able to append a city business registration license. Similarly, other commercial entities (e.g., 130), such as banks, employers, and retailers, may be able to enter into smart contracts (e.g., 140) to append records and, if permitted, have greater visibility over a subscriber's data. The system eliminates the need for subscribers to duplicate the effort to manage and secure a silo of data, and in some cases, the need for intermediaries and third-party validation. Thus, the system can significantly reduce the risk of fraud, cyberattacks, and mistakes that occur due to out-of-date or invalid/corrupted data which add to the cost and complexity of conducting industry or mandatory data security certifications required today.

For example, if an individual moves to a new location and job, a stack of papers from a variety of different stakeholders must be filled out and submitted to effect the change. The process is complex, cumbersome, and rarely smooth, not forgetting how challenging the process is today when changing healthcare providers. Businesses today and in the future will use online and mobile channels to manage customer changes, subscriptions, preferences, and data. Transaction volumes are growing exponentially pushing the limits of current systems and exposing the complexities, vulnerabilities, and inefficiencies. With each entity managing its own silo of information, regulatory and business entities not only have a significant cost issue but also a huge financial risk if the data is hacked or exposed.

According to an aspect of this disclosure, a permissioned blockchain-based system (e.g., system 100) may be established that is a distributed ledger to facilitate the process of storing personal data records of an individual across their lifetime, which may be accessed from anywhere in the world. The system may also facilitate the storage and management of smart contracts with regulatory and business entities permissioned by the individual or jointly with the individual's consent for the purposes of accessing, adding, and updating personal data records. Personal information may be recorded once and may be available safely and securely to all authorized entities in the distributed network. Personal data history may be tamper-proof. According to some embodiments, a personal data record, when added to the chain, may not be changed and may only be updated with another record added to the blockchain. Both records may be visible in the personal data history and to any entity when that record is accessed.

The foundation of the system may have safeguards implemented for data security, privacy, and compliance with published standards for every transaction with the system. The system may include extensive checks for authentication, data accuracy, and privacy with automated checks to ensure compliance with stringent published data security and privacy standards for every interaction. The rapid pace of technological advancement will result in an evolving regulatory landscape, and the system may utilize quantum-resistant encryption, decentralized identity management, and machine-learning threat detection and response algorithms to ensure data integrity.

Furthermore, according to an aspect of this disclosure, this system may become the single trusted source of a subscriber's data, which is accurate and current. Subscribers interacting with the system may receive one or more unique PID (Personal IDentifier) Reference Tokens to verify which records were accessed, appended, and provide a history of accesses and appends. Embodiments may mitigate the need for regulatory and business entities to store personal data in their respective silos, but they may still have the option to do so if they choose. Data stored by the system may be considered the “trusted source” since it will have been pre-verified and it will be assigned a PID. When a subscriber requests retrieval of information associated with a PID it may automatically obtain updated previously accessed information along with a newly appended record and corresponding PIDs. The system is economical and efficient because it eliminates duplication of effort and establishes a networked system that is fast, trusted, and transparent for both the individual and all subscribers. Subscribers will have the option of receiving real-time or consolidated notifications when records are accessed and updated.

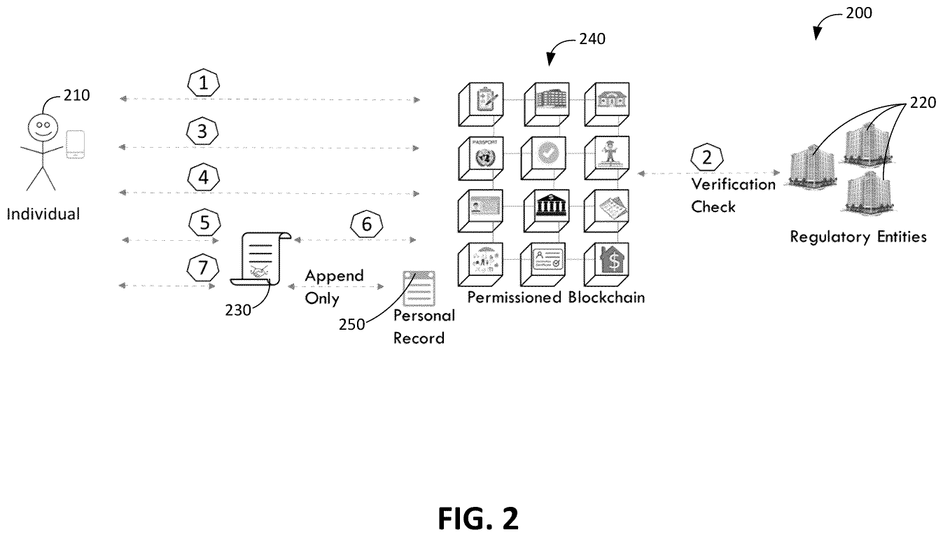

FIG. 2 is a diagram that details a process 200 by which a new individual 210 subscribes to the service, according to an embodiment. The process 200 may be performed by a permissioned blockchain-based system, such as the system 100 of FIG. 1. Various components illustrated in the diagram of FIG. 2 may correspond with those described with respect to FIG. 1 above. The numbers in FIG. 2 correspond to operations described in the paragraphs that follow.

Operation 1: An individual 210 (e.g., corresponding to individual 110 of FIG. 1) may use a mobile or other device with access to the internet to request a subscription. The subscriber 210 may need to opt in to allow the system access to their personal information, including biometric data, medical records, birth certificates, and regulatory information. They may provide explicit consent for the system to collect, store, and analyze this data for the purpose of identification. The service will request pertinent details from the subscriber to authenticate the subscriber 210. The information collected securely by the system may include a birthday, a recent photograph, next of kin, data, etc. The information requested may be different for each subscriber.

Operation 2: The system may verify the information provided by the subscriber 210 with one or more regulatory and/or other entities 220. The intent of using more than one source to verify the same information may be to develop confidence in subscriber authentication to establish the subscriber 210 as the source of personal data records to be appended.

Operation 3: The subscriber's biometric data is initially enrolled into the system. According to some embodiments, this could include fingerprints, iris scans, facial recognition data, voice patterns, and even unique biometric markers such as gait analysis or vein patterns. The system may continuously monitor the subscriber's biometric data for changes. This includes periodic updates to biometric scans to ensure accuracy and adjust for changes due to aging or health complications by monitoring the data collected via medical sensors, wearable devices and medical records. According to some embodiments, the system may utilize machine learning algorithms to analyze the collected biometric and behavioral data. It learns unique patterns and characteristics specific to the individual 210, creating a personalized identification model. As the individual 210 ages or experiences health complications such as memory loss, sight, or hearing loss, the system can adapt its identification model accordingly. It may prioritize specific biometric modalities over others or adjust sensitivity thresholds to accommodate changes in the person's capabilities. For example the system may choose to include speed recognition along with touch to login when it detects the subscriber is having issues with just touch (e.g. shaking). The process will be automatic and the system will also guide the subscriber when adjustments to biometric modalities are introduced. In cases where additional verification is needed or when certain biometric data is unavailable or inconclusive, the system may employ multi-factor authentication techniques. This could involve verifying identity through a combination of biometric data, contextual information (such as location or time of access), and secondary authentication methods like trusted contacts or security questions. According to some embodiments, by learning in this manner, the system can effectively identify the subscriber 210 without needing passwords or tokens, leveraging their unique biometric and behavioral characteristics.

Through continuous learning, biometric authentication will mature, which may make passwords or multi-factor authentication obsolete. The learned biometric authentication May also detect when someone other than the authorized subscriber is attempting to access the system or a subscriber's device fraudulently or even post an article or message if they were to access a logged-in device. The system could trigger an alert, request additional authentication steps to confirm identity, automatically flag the article or message as fraudulent, or indicate the source as unconfirmed.

Operation 4: The system may then generate and share a set of cryptographic keys for the smart contract with the subscriber's access device. The system employs a secure key generation algorithm that utilizes a combination of the subscriber's biometric data, such as fingerprints or iris scans, along with other personal information. This algorithm generates a unique cryptographic key that is mathematically derived from the subscriber's data. According to some embodiments, the cryptographic keys may not be static, may utilize information obtained from subscriber authentication, may use keys that continue to evolve over the lifetime of the account, or any combination thereof. By leveraging cryptographic keys generated from the subscriber's data and employing robust authentication and encryption protocols, the system ensures secure access to the subscriber's data by while maintaining privacy and confidentiality.

Operation 5: The new subscriber 210 may be presented with a smart contract 230 to review and accept. The smart contract 230 may specify the terms and conditions of the service, access credentials, and conditions for accessing and appending records. Using the data gathered during the authentication, the subscriber 210 may be provided a list of regulatory or business entities 220 who, as subscribers of the system, may have (e.g., be given permissions) personal data records of the new subscriber 210. The new subscriber 210 may have the option to set access and append conditions for other subscribers. The new subscriber 210 may also view a list of public subscribers of the system and individually add/remove subscribers to the smart contract. Among other things, smart contracts (e.g., smart contract 230) may dictate access permissions of data. For example, one of the conditions of a subscriber's smart contract 230 may be to provide permissions for a trusted entity to have read/write access to a subscriber's data. (As used herein, the term “trusted entity” is an entity whose data can be trusted e.g. a regulatory entity such the US Dept. of State which has passport data.) For example, when a subscriber is at school, the school may append course/college transcripts. The conditions may dictate that the permissions are only valid when the subscriber is at school, the subscriber has viewed the transcripts, and has provided approval for appending.

Operation 6: Upon acceptance of the terms and conditions specified in the smart contract 230, the smart contract may be appended to the blockchain 240. At this point, the subscription process to the service has been completed, and the new subscriber 210 may have access to the system to append and view data records.

Operation 7: The new subscriber 210 now may be able to append a personal record 250 subject to the terms and conditions of the smart contract 230.

According to some embodiments, a permissioned blockchain-based system as described herein may have predefined smart contracts to which additional rules may be added over time. For example, a smart contract for an individual may include conditions for accessing personal information such as username, password, visual identification data, biometric data, etc., which may evolve and change over a person's lifetime. The system may evolve to secure personal data such that the system and not the subscriber may be responsible for updating access credentials.

Similarly, known or trusted subscribers may have to enter into smart contracts to specify conditions for data access and for visibility accept the condition that individual subscribers may be notified of every access. The interface between subscribers and the system may continually evolve over time for security enhancements.

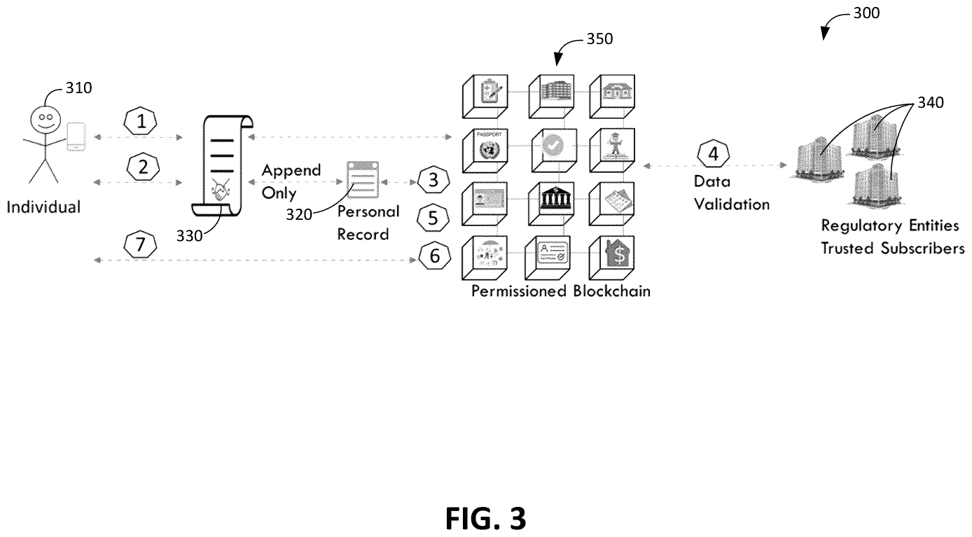

FIG. 3 is a diagram that details a process 300 by which an individual 310 may append an individual subscriber data record, according to an embodiment. Similar to the process 200 of FIG. 2, the process 300 may be performed by a permissioned blockchain-based system, such as the system 100 of FIG. 1. Various components illustrated in the diagram of FIG. 3 may correspond with those described with respect to FIG. 1 above. The numbers in FIG. 3 correspond to operations described in the paragraphs that follow.

Operation 1: A subscriber 310 may use their device to access the site securely using their credentials and multi-factor process assigned during the new subscription process.

Operation 2: When the subscriber 310 submits a personal record 320 for appending, the terms and conditions in the smart contract 330 may be executed to verify the validity of the data. The terms and conditions may include verification of the data by contacting one or more independent or regulatory entities 340. For example, if a subscriber submits the subscriber's birth certificate, one of the conditions may require approval from one or more regulatory and legal entities. If approval is received the record is appended along with the results or documentary evidence of the approval. If approval is denied, the request and reasons/evidence why it was denied are also captured and appended as a record.

Operation 3: The personal record 320 may be accepted and stored in a secure temporary holding location until the contents are validated. A database on a server, for example, may serve as a temporary store for data records awaiting validation in a secure private blockchain.

Operation 4: The record for appending may be validated through one or multiple means, which may include contacting the original source of the information for confirmation and/or contacting one or more trusted subscribers and/or regulatory entities 340.

Operation 5: When the data for appending has been validated, the data record may be appended to the block chain 350 and available for authorized subscribers to view. Data that could not be validated is not visible to authorized subscribers and only visible to the subscriber/owner of the data.

Operation 6: When a subscriber record is appended, the system may generate encryption keys for different information types (unique to the individual 310 and not shared with anyone). These keys can be read only and write/accessible. This may put the subscriber 310 firmly in control of their personal information.

At operation 7: The subscriber 310 may be notified of data validation/append or, if validation fails or the appending fails for any other reason, provided a reason for the rejection.

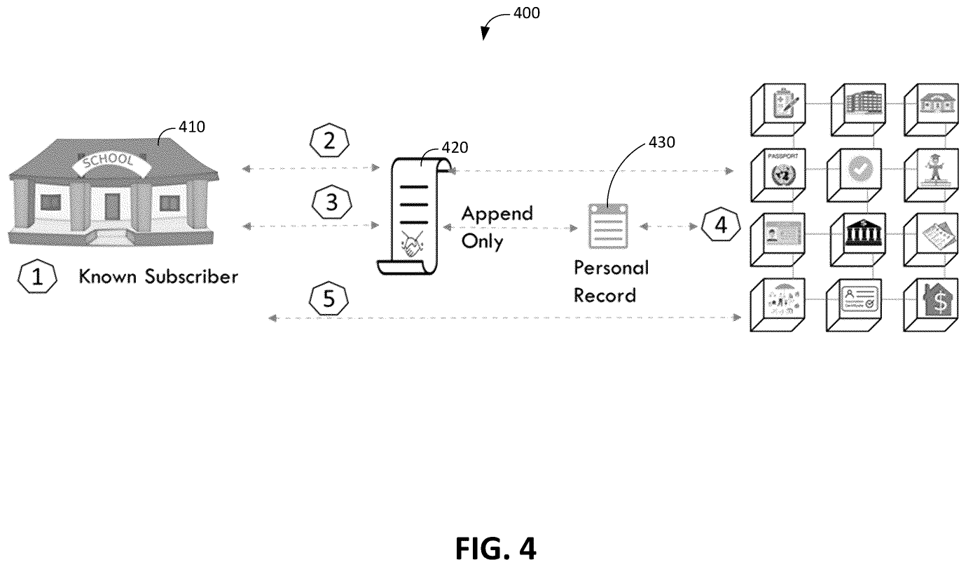

FIG. 4 is a diagram that details a process 400 by which a data record may be appended by a known (trusted) subscriber 410, according to an embodiment. The process 400 may be performed by a permissioned blockchain-based system, such as the system 100 of FIG. 1. Various components illustrated in the diagram of FIG. 4 may correspond with those described with respect to FIG. 1 above. The numbers in FIG. 4 correspond to operations described in the paragraphs that follow.

Operation 1: Certain institutions such as schools, medical authorities, and regulatory bodies may be granted known or trusted source status following the initial subscription process. A known subscriber 410 may have its own set of keys and the access conditions in its smart contract 420 may ensure public visibility of its operations. A smart contract with known sources may differ in that known subscribers may also be able to add/delete access conditions in smart contracts of other subscribers. For example, a known college may modify a smart contract of subscribed students to allow access to college transcripts.

Operation 2: A subscriber may access the system using their credentials and multi-factor process assigned during the new subscription process. Here, because records in blockchain are owned by the individual subscriber, smart contract 420 may provide the known entity (school) access permissions to append records.

Operation 3: The known subscriber 410 may append a record (e.g., a personal record of an individual, who may also be a subscriber of the system). Since the subscriber may be a known entity, the access condition in the smart contract 420 may indicate proof the known subscriber 410 must submit to show the validity of the data record. The intent is to prevent the addition of altered records without the subscriber's knowledge. For example, a school has added a record for student transcripts for 2022. If there is another attempt to update the record for 2022, the subscriber may want to know why. The smart contract can specify the additional proof or validation before the subscriber grants access. Proof of data validation may vary for subscribers, and the conditions for validation may be determined during the enrollment of a known subscriber.

Operation 4: When a data record is appended, the system may generate keys for visible access privileges. Other subscribers who wish to access the record and have the privileges listed in their smart contract may be assigned one of the generated keys upon request, with which they may be able to view the date. The key may be unique for each subscriber.

Operation 5: the known subscriber 410 may be notified of appending of the record 430, or if the record 430 is not appended, provided a reason for the rejection.

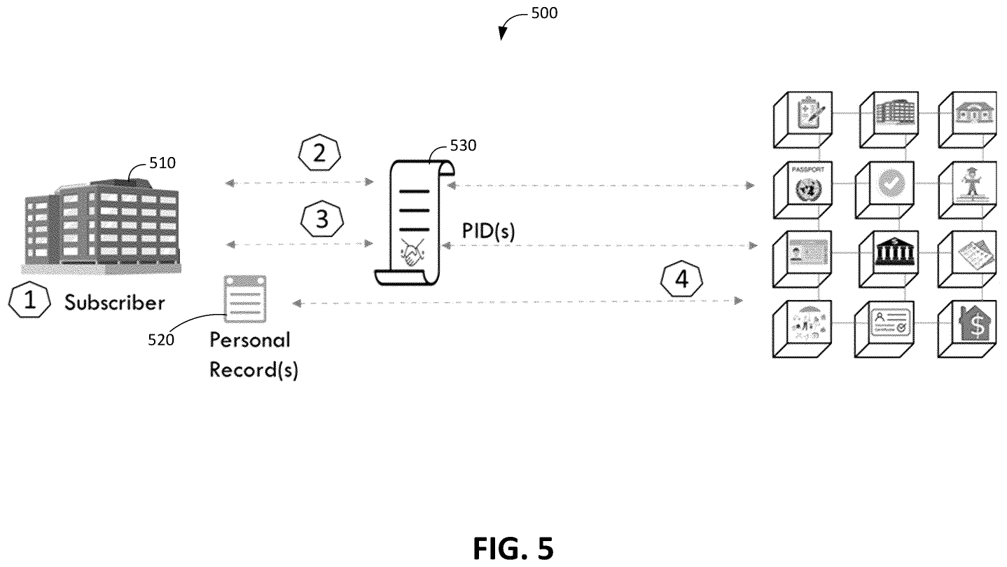

FIG. 5 is a diagram that details a process 500 by which a subscriber 510 accesses a data record 520 using a PID, according to an embodiment. In this cases, a subscriber 510 may be an entity such as employer that wishes to verify an individual subscriber's employment record. It could also be a social media site authenticating an individual subscriber as a real person who's trying to create an account (deter fake/bot accounts). The process 500 may be performed by a permissioned blockchain-based system, such as the system 100 of FIG. 1. Various components illustrated in the diagram of FIG. 5 may correspond with those described with respect to FIG. 1 above. The numbers in FIG. 5 correspond to operations described in the paragraphs that follow.

Operation 1: A subscriber 510 may access the system using their credentials and multi-factor process assigned during the new subscription process.

Operation 2: The subscriber 510 may request access to a particular record 520.

Operation 3: Per conditions listed in the smart contract 530, the system may return PID(s) with which the subscriber 510 can retrieve the records. The PID Reference Token may comprise a unique reference for the subscriber 510 that identifies the records a subscriber can access. The PID may be saved by the subscriber 510 and used again to retrieve the same record 520.

Operation 4: The subscriber may retrieve the desired records with the provided PIDs. The system may communicate securely with a subscriber's mobile devices, desktops, and/or servers managed by entities. The eventual aim is for the system to be the single source of truth and deter or minimize data that is provided to others. When a subscriber is being authenticated, the PID may evolve to include sufficient data to authenticate a subscriber without access to other records.

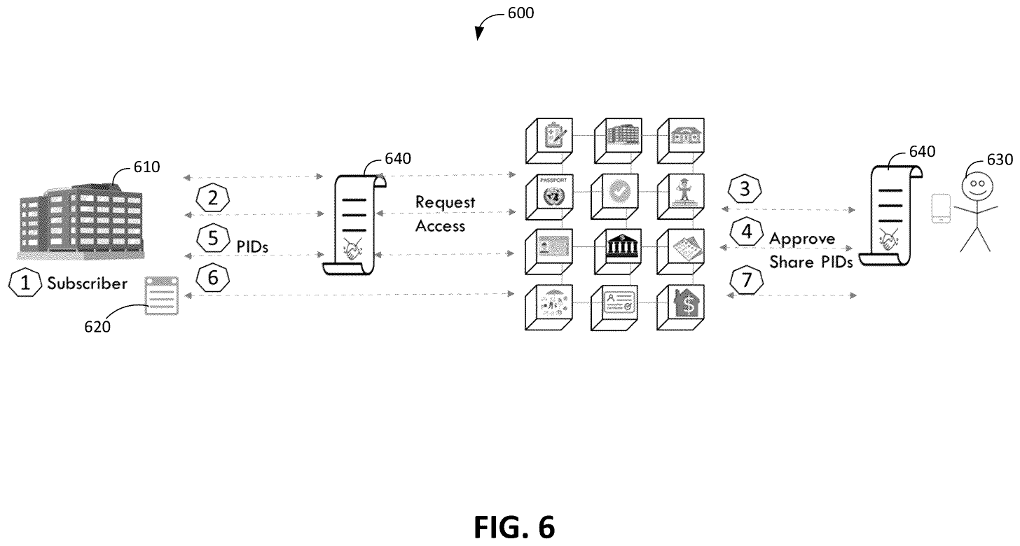

FIG. 6 is a diagram that details a process 600 by which data is verified or a subscriber 610 is authenticated, according to an embodiment. The process 600 may be performed by a permissioned blockchain-based system, such as the system 100 of FIG. 1. Various components illustrated in the diagram of FIG. 6 may correspond with those described with respect to FIG. 1 above. The numbers in FIG. 6 correspond to operations described in the paragraphs that follow.

Operation 1: A subscriber 610 may access the system using their credentials and multi-factor process assigned during the new subscription process.

Operation 2: the subscriber 610 may request an individual record 620 for verification. For example, a subscriber 610 comprising a prospective employer may want to verify the education records of a prospective employee.

Operation 3: The request may be submitted to the individual subscriber 630 (e.g., the individual whose record is requested by the subscriber 610) for permission.

Operation 4: The individual subscriber 630 may receive a notification of the request and approve access, and the system may then generate and share one or more PIDs for the specified information with the requesting subscriber 610. The records may be read-only and the PIDs may point to one or more blocks. For instance, if the individual has records for school such as “high school: generic high school” and then later a college entity has added “college: generic college”, “degree: applied math”. The PIDs may reference these blocks to show the history.

Operation 5: The PIDs may be shared with the requesting subscriber 610.

Operation 6: The subscriber 610 may access the data record using the PIDs.

Operation 7: The individual subscriber 630 may be notified of access.

FIG. 6 also illustrates the process by which an online or business entity such as a social media company may verify an individual without accessing personal data. The smart contract 640 may also indicate conditions an individual subscriber may set with regard to external authentication, limitations, privacy, and storage sharing of data. In some embodiments, the smart contract may be the same for all, only the conditions for data access will be different. The subscriber may not have control over the data held by an entity, but a subscriber can manage entity access. Non-subscribers may have a standard smart contract by which they can request authentication of a subscriber. (According to some embodiments, for non-subscribers there may be a standard contract which will provide access to a limited set of records, for example, name, address, e-mail address, etc. The standard contract and the records that will shared with a non-subscriber may be defined in the subscriber's terms and conditions.) The system may use the data provided by the non-subscriber to authenticate and, if successful, generate a unique public PID which may be returned to the non-subscriber. The public PID may point to the results of the authentication request. The system may also notify the individual subscriber that an authentication request was made and the PID that was shared. Using the technique described herein, embodiments may prevent the sharing of personal data unless it is necessary and, in some cases, a non-subscriber may be granted access to the personal data if allowed by the smart contract and approved by the individual subscriber (e.g., individual subscriber 630).

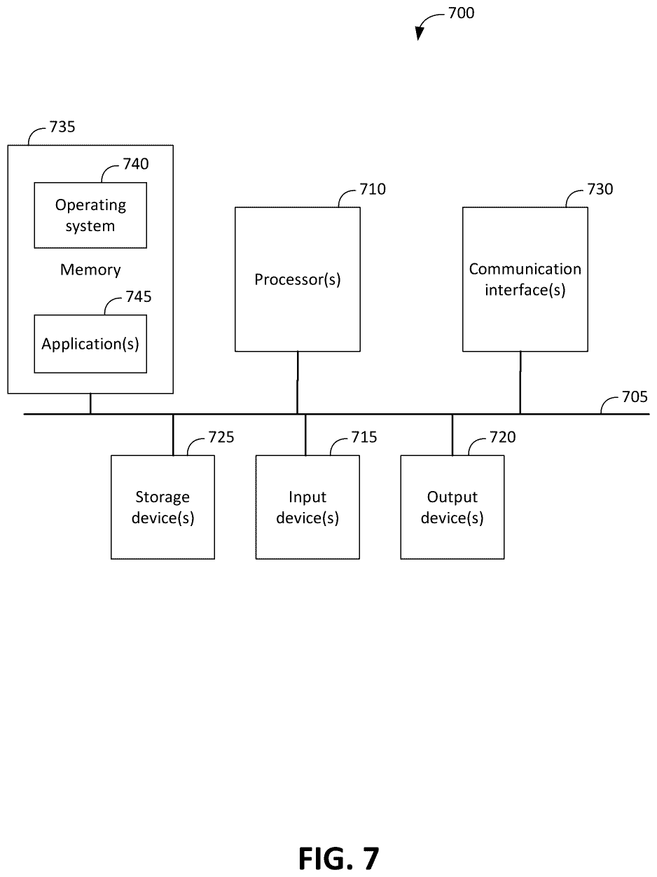

FIG. 7 is a block diagram of an embodiment of a computer system 700, which may be used, in whole or in part, to provide the functions of one or more components and/or devices as described in the embodiments herein. The computer system 700, for example, may be utilized within and/or executed by a personal computer, server, mobile device, or the like, to access and/or implement components of a permissioned blockchain-based system, such as the system 100 of FIG. 1. The computer system 700 may, for example, comprises smart phone that executes an application by which an individual (e.g., an individual subscriber as described herein) may interact with a permissioned blockchain-based system as described herein. Additionally, or alternatively, the computer system 700 may comprise multiple computers or servers that manage the distributed block chain ledger, constantly checking and ensuring date integrity and completeness with which an entity may access the permissioned blockchain-based system as described herein. Additionally or alternatively, a computer system 700 may store components of the permission blockchain, provide an interface (e.g., web portal) with which a PID and/or other information may be obtained, and/or perform other functions of a permissioned blockchain-based system, as described herein. Moreover, functionality may be performed “in the cloud” across multiple computer systems, such as the computer system 700, which may be communicatively linked with each other. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. In addition, it can be noted that components illustrated by FIG. 7 can be localized to a single device and/or distributed among various networked devices, which may be disposed at different geographical locations.

The computer system 700 is shown comprising hardware elements that can be electrically coupled via a bus 705 (or may otherwise be in communication, as appropriate). The hardware elements may include processor(s) 710, which may comprise one or more general-purpose processors, one or more special-purpose processors (e.g., graphics acceleration processors, digital signal processors, and/or the like), and/or other processing structure, which can be configured to perform one or more of the methods described herein. The computer system 700 also may comprise one or more input devices 715, which may comprise, for example, a mouse, a keyboard, a touchscreen, a touchpad, a camera, a microphone, and/or the like. Input devices may include one or more sensors (e.g., camera, fingerprint sensor, accelerometers, gyroscopes, etc.) capable of obtaining biometric information from a user/subscriber as described herein. The computer system 700 may also include one or more output devices 720, which may comprise, for example, a display, a speaker, and/or the like.

The computer system 700 may further include (and/or be in communication with) one or more non-transitory storage devices 725, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to other devices and/or computers, to implement the operations described herein.

The computer system 700 may also include one or more communication interfaces 730, which may comprise comments utilizing wired and/or wireless communication technologies (such as Wi-Fi, cellular, Ethernet, coaxial communications, universal serial bus (USB), and the like). Thus the communication interface(s) 730 may comprise a modem, a network card (wireless or wired), an infrared communication device, a wireless communication device, and/or a chipset, and/or the like, which may enable the computer system 700 to communicate on communication networks (e.g., the Internet) to other devices, computers, and systems, to implement the systems and methods described herein. Hence, the communication interface(s) 730 may be used to receive and send data (e.g., access requests, personal records, etc.) as described in the embodiments herein.

In many embodiments, the computer system 700 will further comprise a working memory 735, which may comprise a RAM or ROM device, as described above. Software elements, shown as being located within the working memory 735, may comprise an operating system 740, device drivers, executable libraries, and/or other code, such as one or more applications 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

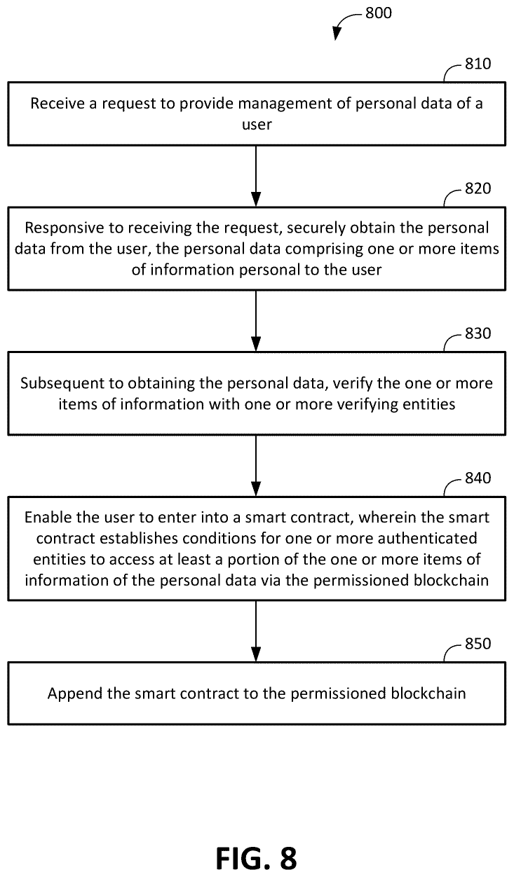

FIG. 8 is a flow diagram of a method 800 of providing protected personal data management using a permissioned blockchain, according to an embodiment. One or more operations in the blocks illustrated in FIG. 8 may be performed by a permissioned blockchain-based system, such as the system 100 illustrated in FIG. 1. Moreover, one or more of the operations illustrated in FIG. 8 may reflect functionality described in FIGS. 2-6. More specifically, the method 800 may reflect aspects of the process 200 depicted in FIG. 2 in which an individual subscribes to the service. Further, the functionality may be performed by one or more computer systems, such as the computer system 700 illustrated in FIG. 7, which may comprise a computer server, mobile device, or the like, as previously noted. As such, means and/or structure for performing the operations illustrated in FIG. 8 may comprise software and/or hardware means as illustrated in FIG. 7.

The functionality at block 810 comprises receive a request to provide management of personal data of a user. Here, a “user” may correspond with a “individual” or “individual subscriber” as described in the above embodiments. The request to provide management of personal data may be part of the process of onboarding a user when a user first subscribes to the service providing protected personal data management using a permissioned blockchain, for example. The request itself may be received at the user's device (e.g., via an application and/or user interface). Additionally or alternatively, the request may be considered a request from the user device, in which case the request may be received from the user device at a server configured to subscribe individuals to the service. According to some embodiments, the request may further include authentication information of the user. According to some embodiments, the method 800 may further comprise establishing multi-factor authentication with the user for accessing the permissioned blockchain.

The functionality at block 820 comprises, responsive to receiving the request, securely obtaining the personal data from the user, the personal data comprising one or more items of information personal to the user. As previously noted, these items of information may include identification instruments (e.g., school card, driver's license, passport, etc.), biometric information, medical records, birth certificate, and/or other items of data that may be stored in a personal record, as described herein. In some embodiments, a mobile device may obtain biometric information using one or more sensors (e.g., camera, fingerprint sensor, accelerometers, gyroscopes, etc.).

The functionality at block 830 comprises, subsequent to obtaining the personal data, verifying the one or more items of information with one or more verifying entities. As described with respect to operation 2 in FIG. 2, the various verifying entities may comprise, for example, regulatory entities capable of verifying personal information provided by the user. Verification may be made, for example, by a communication exchange between a server and/or a user device and one or more of the verifying entities.

The functionality at block 840 comprises enabling the user to enter into a smart contract, wherein the smart contract establishes conditions for one or more authenticated entities to access at least a portion of the one or more items of information of the personal data via the permissioned blockchain. As described herein, this can be done by allowing an individual to enter into the smart contract via a user device, web portal (e.g., hosted by server), or the like.

The functionality at block 850 comprises appending the smart contract to the permissioned blockchain. That is, once the smart contract is entered into by a user, it can be stored in the block chain. According to some embodiments, receiving the request, obtaining the personal data from the user, enabling the user to enter into the smart contract, or any combination thereof, is/are performed over an encrypted communication session between a server and a user device.

As noted in the embodiments herein, once a user enters into a smart contract in this manner, entities may access the one or more items of information personal to the user (e.g., personal records) in accordance with permissions granted to the entities. Thus, embodiments of the method 800 may further comprise granting an authenticated entity access to the at least a portion of the one or more items of information of the personal data via the permissioned blockchain, in accordance with the smart contract.

Depending on desired functionality, the method may further comprise one or more additional features, as described above. For example, according to some embodiments, the method 800 may further comprise sharing a cryptographic key for the smart contract with a user device. In such embodiments, the cryptographic key may be periodically updated, uses information obtained from subscriber authentication, or any combination thereof. According to some embodiments, the smart contract may further establish credentials for the one or more authenticated entities to access the at least a portion of the one or more items of information of the personal data. According to some embodiments, the method 800 may further comprise providing the user with a list of regulatory entities, business entities, or both, that may have personal data records of the user. Additionally or alternatively, the method may comprise enabling the user to modify permissions of one or more of the authenticated entities for accessing the at least a portion of the one or more items of information of the personal data. According to some embodiments, the method may comprise enabling the user to remove at least a portion of the one or more of the authenticated entities from the smart contract.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description, embodiments may include different combinations of features. Implementation examples are described in the following numbered clauses:

Clause 1. A method of providing protected personal data management using a permissioned blockchain, the method comprising: receiving a request to provide management of personal data of a user; responsive to receiving the request, securely obtaining the personal data from the user, the personal data comprising one or more items of information personal to the user; subsequent to obtaining the personal data, verifying the one or more items of information with one or more verifying entities; enabling the user to enter into a smart contract, wherein the smart contract establishes conditions for one or more authenticated entities to access at least a portion of the one or more items of information of the personal data via the permissioned blockchain; and appending the smart contract to the permissioned blockchain.

Clause 2. The method of clause 1, further comprising granting an authenticated entity access to the at least a portion of the one or more items of information of the personal data via the permissioned blockchain, in accordance with the smart contract.

Clause 3. The method any one of clauses 1-2, wherein the request further includes authentication information of the user.

Clause 4. The method of any one of clauses 1-3, wherein receiving the request, obtaining the personal data from the user, enabling the user to enter into the smart contract, or any combination thereof, is/are performed over an encrypted communication session between a server and a user device.

Clause 5. The method of any one of clauses 1-4, further comprising establishing multi-factor authentication with the user for accessing the permissioned blockchain.

Clause 6. The method of any one of clauses 1-5, further comprising sharing a cryptographic key for the smart contract with a user device.

Clause 7. The method of clause 6, wherein the cryptographic key is periodically updated, uses information obtained from subscriber authentication, or any combination thereof.

Clause 8. The method of any one of clauses 1-6, wherein the smart contract further establishes credentials for the one or more authenticated entities to access the at least a portion of the one or more items of information of the personal data.

Clause 9. The method of any one of clauses 1-8, further comprising providing the user with a list of regulatory entities, business entities, or both, that may have personal data records of the user.

Clause 10. The method of any one of clauses 1-9, further comprising enabling the user to modify permissions of one or more of the authenticated entities for accessing the at least a portion of the one or more items of information of the personal data.

Clause 11. The method of any one of clauses 1-10 further comprising enabling the user to remove at least a portion of the one or more of the authenticated entities from the smart contract.

Clause 12. A method of appending personal data to a personal data record managed using a permissioned blockchain, the method comprising: receiving a request to append new data to a personal data record having personal data of a user, the personal data comprising one or more items of information personal to the user; responsive to receiving the request: storing the new data in a temporary storage during validation, and validating the new data in accordance with a smart contract associated with the personal data record and maintained by the permissioned blockchain; responsive to successfully validating the new data, appending the new data to the personal data record and removing the new data from the temporary storage; and subsequent to appending the new data to the personal data record, sending a notification that the new data was appended to the personal data record.

Clause 13. The method of clause 12, wherein the temporary storage comprises a secure database.

Clause 14. The method of any one of clauses 12-13, wherein validating the new data in accordance with the smart contract comprises contacting one or more independent or regulatory entities identified in the smart contract.

Clause 15. The method of any one of clauses 12-14, wherein validating the new data comprises contacting a source of the new data.

Clause 16. The method of clause 15, wherein the source of the new data comprises (i) a trusted subscriber to the permissioned blockchain or (ii) a regulatory agency.

Clause 17. The method any one of clauses 12-16, wherein the new data comprises a plurality of types of information personal to the user.

Clause 18. The method of clause 17, further comprising generating an encryption key for each type of information of the plurality of types of information, of the new data wherein each encryption key is unique to the user and enables access to a respective type of information of the new data.

Clause 19. The method of any one of clauses 12-18, wherein the request is received from a requesting entity, and wherein the method further comprises authenticating an identity of the requesting entity.

Clause 20. The method of clause 19, wherein the requesting entity comprises (i) the user, or (ii) a trusted source comprising a source of the new data.

Clause 21. The method of method of any one of clauses 12-20, further comprising setting permissions for one or more entities other than the user to access the new data.

Clause 22. The method of clause 21, further comprising generating a respective encryption key for each of the one or more entities, wherein the respective encryption key enables a respective entity of the one or more entities access to the new data in accordance with the permissions for the respective entity.

23. A method of granting access to personal data in a personal data record managed using a permissioned blockchain, the method comprising: receiving a request from a requesting entity to access the personal data, the personal data comprising one or more items of information personal to a user; responsive to receiving the request, determining that the requesting entity may access the personal data; and responsive to determining that the requesting entity may access the personal data: generating one or more personal identifier (PID) reference tokens to be used by the requesting entity to access the personal data, wherein the one or more PID reference tokens: are unique to the requesting entity, are indicative of the personal data requested by the requesting entity, and enable access to the personal data; and providing the one or more PID reference tokens to the requesting entity.

Clause 24. The method of clause 23, further comprising establishing multi-factor authentication of the requesting entity in association with receiving the request.

Clause 25. The method of method of any one of clauses 23-24, wherein determining that the requesting entity may access the personal data comprises determining that access to the personal data by the requesting entity is in accordance with a smart contract associated with the personal data record and maintained by the permissioned blockchain.

Clause 26. The method of any one of clauses 23-25, wherein determining that the requesting entity may access the personal data comprises: requesting permission from the user for the requesting entity to access the personal data; and receiving the requested permission from the user.

Clause 27. The method of any one of clauses 23-26, further comprising: determining the requesting entity has used the one or more PID reference tokens to access the personal data; and notifying he user that the requesting entity has accessed the personal data.

Clause 28. A device comprising a memory and one or more processors coupled with the memory, wherein the one or more processors are configured to perform the method of any one of clauses 1-27.

Clause 29. A system having means for performing the method of any one of clauses 1-27.

Clause 30. A non-transitory, computer-readable medium having instructions embedded therein, the instructions comprising code for performing the method of any one of clauses 1-27.

What is claimed is:

1. A method of providing protected personal data management using a permissioned blockchain, the method comprising:
receiving a request to provide management of personal data of a user;
responsive to receiving the request, securely obtaining the personal data from the user, the personal data comprising one or more items of information personal to the user;
subsequent to obtaining the personal data, verifying the one or more items of information with one or more verifying entities;
enabling the user to enter into a smart contract, wherein the smart contract establishes conditions for one or more authenticated entities to access at least a portion of the one or more items of information of the personal data via the permissioned blockchain; and
appending the smart contract to the permissioned blockchain.

2. The method of claim 1, further comprising granting an authenticated entity access to the at least a portion of the one or more items of information of the personal data via the permissioned blockchain, in accordance with the smart contract.

3. The method of claim 1, wherein the request further includes authentication information of the user.

4. The method of claim 1, wherein receiving the request, obtaining the personal data from the user, enabling the user to enter into the smart contract, or any combination thereof, is/are performed over an encrypted communication session between a server and a user device.

5. The method of claim 1, further comprising establishing multi-factor authentication with the user for accessing the permissioned blockchain.

6. The method of claim 1, further comprising sharing a cryptographic key for the smart contract with a user device.

7. The method of claim 6, wherein the cryptographic key is periodically updated, uses information obtained from subscriber authentication, or any combination thereof.

8. The method of claim 1, wherein the smart contract further establishes credentials for the one or more authenticated entities to access the at least a portion of the one or more items of information of the personal data.

9. The method of claim 1, further comprising providing the user with a list of regulatory entities, business entities, or both, that may have personal data records of the user.

10. The method of claim 1, further comprising enabling the user to modify permissions of one or more of the authenticated entities for accessing the at least a portion of the one or more items of information of the personal data.

11. The method of claim 1, further comprising enabling the user to remove at least a portion of the one or more of the authenticated entities from the smart contract.

12. A computer system comprising:
a communication interface;
a memory; and
one or more processors communicatively coupled with the communication interface and the memory, the one or more processors configured to:
receive, via the communication interface, a request to provide management of personal data of a user;
responsive to receiving the request, securely obtain the personal data from the user, the personal data comprising one or more items of information personal to the user;
subsequent to obtaining the personal data, verify the one or more items of information with one or more verifying entities;
enable the user to enter into a smart contract, wherein the smart contract establishes conditions for one or more authenticated entities to access at least a portion of the one or more items of information of the personal data via a permissioned blockchain; and
append the smart contract to the permissioned blockchain.

13. The computer system of claim 12, wherein the one or more processors are further configured to grant an authenticated entity access to the at least a portion of the one or more items of information of the personal data via the permissioned blockchain, in accordance with the smart contract.

14. The computer system of claim 12, wherein the one or more processors are further configured to receive the request, obtain the personal data from the user, enable the user to enter into the smart contract, or any combination thereof, over an encrypted communication session with a user device via the communication interface.

15. The computer system of claim 12, wherein the one or more processors are further configured to establish multi-factor authentication with the user for accessing the permissioned blockchain.

16. The computer system of claim 12, wherein the one or more processors are further configured to share a cryptographic key for the smart contract with a user device.

17. The computer system of claim 16, wherein the one or more processors are further configured to periodically update the cryptographic key, use information obtained from subscriber authentication, or any combination thereof.

18. The computer system of claim 12, wherein the one or more processors are further configured to provide the user with a list of regulatory entities, business entities, or both, that may have personal data records of the user.

19. The computer system of claim 12, wherein the one or more processors are further configured to modify permissions of one or more of the authenticated entities for accessing the at least a portion of the one or more items of information of the personal data.

20. A non-transitory, computer-readable medium having instructions embedded therein for providing protected personal data management using a permissioned blockchain, the instructions comprising code for:
receiving a request to provide management of personal data of a user;
responsive to receiving the request, securely obtaining the personal data from the user, the personal data comprising one or more items of information personal to the user;
subsequent to obtaining the personal data, verifying the one or more items of information with one or more verifying entities;
enabling the user to enter into a smart contract, wherein the smart contract establishes conditions for one or more authenticated entities to access at least a portion of the one or more items of information of the personal data via the permissioned blockchain; and
appending the smart contract to the permissioned blockchain.
